(19) United States
(12) Patent Application Publication
(10) Pub. No.: US 2008/0271832 A1
(43) Pub. Date: Nov. 6, 2008

(54) Thermo-conductive, heat-shrinkable, dual-wall tubing

(75) Inventors: George J. Pieslak, Atherton, CA (US); Leon C. Glover, Los Altos, CA (US); Alan W. Keeley, Redwood City, CA (US); Jim J. Imperiale, Fremont, CA (US); Tony G. Alvernaz, Bethel Island, CA (US); R. John Dolinsek, Loma Mar, CA (US)

Correspondence Address: Tyco Electronics Corporation, 309 Constitution Drive, Mail Stop R34/2A, Menlo Park, CA, 94025, US

(73) Assignee: Tyco Electronics Corporation, Middletown, PA (US)

(21) Appl. No.: 11/800,306

(22) Filed: May 4, 2007

(51) Int. Cl. B65B 53/02; B32B 37/06; F16B 4/00

(52) U.S. Cl. 156/85; 428/34.9

(57) ABSTRACT

A tubing system (or construction) comprising an inner wall composed of a thermo-conductive adhesive composition, wherein the thermo-conductive adhesive composition comprises a thermo-conductor admixed with an adhesive, and the thermo-conductor is at least about 45% of the weight of the thermo-conductive adhesive composition; and an expanded polymeric outer jacket surrounding and in contact with the inner wall, wherein the expanded polymeric outer jacket recovers (i.e., shrinks) at a predetermined temperature, e.g., when heat is applied.

### FIELD OF THE INVENTION

The present invention is directed to thermo-conductive, heat-recoverable (e.g., heat-shrinkable), dual-wall tubing, methods for their manufacture, and uses thereof.

### BACKGROUND OF THE INVENTION

Several heat-shrinkable tubing materials are commercially available. They are often used for environmental protection because they can be produced over-sized, easily installed and then shrunk into tight, sealing engagement with the substrate to be protected. Some heat-shrinkable tubing is internally coated with an adhesive such that the heating required for installation causes both shrinkage of the article and activation of the adhesive. In this way, an excellent environmental seal can be produced.

Example adhesives that may be used in the interior of heat-shrinkable tubing include greases, pastes and gels, which have minimal binding strength and therefore have limited application. Other adhesives, e.g., pressure sensitive acrylate and silicone adhesives, may be employed, but they are often difficult to handle because they may bind a substrate before the tubing is properly installed or the inner wall of the tubing may collapse and bind to itself, thereby making the tubing unusable. Other adhesives that may be used within heat-shrinkable tubing include two-part curing adhesives, e.g., epoxy and silicone, which are typically made from liquids that must be mixed and immediately applied. Although such two-part adhesives offer excellent bonding strength, it is often impractical to coat tubing with a two-part liquid composition, e.g., by completely immersing the tubing, and then to install the tubing before the curing process begins to impede recovery of the expanded polymer.

Furthermore, such adhesives are typically poor conductors of heat, and therefore existing heat-shrinkable tubings are of limited usefulness in certain applications. For example, when heat-shrinkable tubing is to be used in a heat exchanger or a refrigeration system, it is often necessary for the components within the tubing to be in thermal communication with each other. Likewise, in certain electronics applications, it may be desirable for electrically shielded wires to be in thermal contact with, e.g., a temperature probe.

Accordingly, a need exists for a thermo-conductive, heat-recoverable (e.g., heat-shrinkable) tubing that satisfies these needs, as well as others, and generally overcomes the deficiencies found of existing materials.

### SUMMARY OF THE INVENTION

In an example embodiment, the invention includes a tubing system (or construction) comprising (1) an inner wall composed of a thermo-conductive adhesive composition, wherein the thermo-conductive adhesive composition comprises a thermo-conductor admixed with an adhesive, and the thermo-conductor is at least about 45% of the weight of the thermo-conductive adhesive composition; and (2) an expanded polymeric outer jacket surrounding and in contact with the inner wall, wherein the expanded polymeric outer jacket recovers (e.g., shrinks) at a predetermined temperature, e.g., when heat is applied.

The thermally conductive inner wall may be employed to contact and adhere to a substrate or article, and the outer jacket layer acting as a driver when the tubing is recovered. Upon heat-shrinking, the outer jacket forces or squeezes the inner wall into tight contact with the articles within the tubing. This phenomenon is facilitated by the use of an adhesive that becomes soft or partially fluid upon heating. Such tubing may be used to bond pipes (e.g., metal or plastic pipes), heater cord or tape or sensors into permanent intimate mechanical and thermal contact. The tubing is particularly useful to allow dissimilar pipes to be held together. In one application, the tubing can be used to replace the brazing that has been conventionally required between copper and steel pipes, e.g., in a refrigeration unit.

In another example embodiment, the invention includes a method of sealing one or more articles comprising the following steps: (1) providing one or more articles to be sealed, a thermo-conductive adhesive composition, and an expanded polymeric outer jacket; (2) placing the thermo-conductive adhesive composition around the articles and within the expanded polymeric outer jacket; and thereafter (3) heating the expanded polymeric outer jacket to (or above) a predetermined temperature, thereby producing a recovered polymeric outer jacket and thereby sealing the thermo-conductive adhesive composition into contact with the articles while leaving essentially no voids (e.g., air pockets) within the adhesive composition and between the adhesive composition and the article, and preferably leaving essentially no voids within the recovered polymeric outer jacket. The thermo-conductive adhesive composition comprises a thermo-conductor admixed with an adhesive, and the thermo-conductor is at least about 45% of the weight of the thermo-conductive adhesive composition. The expanded polymeric outer jacket recovers at or above the predetermined temperature. The adhesive melts or softens at (or above) the predetermined temperature. Upon recovering (e.g., shrinking), the outer jacket compresses the thermo-conductive adhesive composition into contact with the articles, leaving essentially no voids or air pockets. Application of heat during the shrinking process causes the outer jacket to shrink in addition to activating (e.g., melting or softening) the thermo-conductive adhesive composition. In this manner, one or more articles may be sealed and placed in thermal communication.

Other features and advantages of the present invention will be apparent from the following more detailed description of preferred embodiments, taken in conjunction with the accompanying drawings that illustrate, by way of example, some principles of the invention.

### BRIEF DESCRIPTION OF THE DRAWINGS

FIGS. 1 and 2, which are not to scale, illustrate an axial cross-sectional view and a longitudinal cross-sectional view of an example thermo-conductive, heat-shrinkable, dual-wall tubing of an embodiment of the invention.

FIG. 2, which is not to scale, further illustrates the difference in diameter between an example expanded tubing and a recovered tubing.

FIG. 3, which is not to scale, illustrates an assembly of three pipes sealed together within a fully recovered tubing of an embodiment of the invention.

FIG. 4, which is not to scale, illustrates an assembly of two pipes of different size sealed together within a fully recovered tubing of an embodiment of the invention.

### DETAILED DESCRIPTION OF THE INVENTION

In an example embodiment, the invention includes (1) a tubing system (or construction) comprising an inner wall composed of a thermo-conductive adhesive composition, wherein the thermo-conductive adhesive composition comprises a thermo-conductor admixed with an adhesive, and the thermo-conductor is at least about 45% of the weight of the thermo-conductive adhesive composition; and (2) an expanded polymeric outer jacket surrounding and in contact with the inner wall, wherein the expanded polymeric outer jacket recovers (e.g., shrinks) at a predetermined temperature, e.g., when heat is applied.

In an example application, the tubing system may be used for heat transfer (e.g., heat removal or heat gain) between two or more metal pipes, which may be made from the same metal, such as copper, or two different metals, such as copper and steel or copper and aluminum. As the expanded polymeric outer jacket is heated, it shrinks; the thermo-conductive adhesive composition of the inner wall melts or softens and flows around the two or more metal pipes. Recovery of the tubing is generally achieved by heat, e.g., from a torch, resistance wires, or other source, which may be application-specific. The tubing should be heated sufficiently to shrink it but not damage it. Upon cooling the thermo-conductive adhesive composition solidifies around the metal pipes, both holding them in contact with each other and enhancing the heat transfer between them. Accordingly, heat loss between the two or more metal pipes is reduced by placing the pipes in thermal contact with each other and enhancing the heat exchange between them. The dual-wall tubing having a thermo-conductive adhesive composition provides a simple and tidy means for placing pipes into permanent intimate mechanical and thermal contact for a variety of different assemblies and configurations.

In another example embodiment, the expanded polymeric outer jacket comprises a material having the property of elastic memory such as those known in the art. Extruded crystalline polymers and extruded cross-linked crystalline polymeric materials, when heated to a temperature above the crystalline melting point or range, behave as elastomers. Materials having the property of elastic memory are dimensionally heat unstable and may be caused to change shape or dimension simply by the application of heat. Elastic memory may be imparted to polymeric materials by first extruding or otherwise forming, e.g. molding, the polymer into a desired shape. The polymer is then cross-linked or given the properties of a cross-linked material by exposure to high energy radiation, e.g., a high energy electron beam, exposure to ultra-violet irradiation, or by chemical means, e.g., incorporation of peroxides when polyolefins or fluoropolymers are used. The cross-linked polymeric material is then heated and deformed and then locked in that deformed condition by quenching or other suitable cooling. Alternatively, the same process may be accomplished at room temperature (or other temperatures, depending on the materials) by using greater force to deform the polymer. The deformed (expanded) material retains its shape almost indefinitely until exposed to an elevated temperature sufficient to cause recovery, e.g., about 121° C. (250° F.) in the case of low density polyethylene. The expansion can be of the order of 120 to 600 percent, which is often much greater than can be accomplished by simply expanding in the molten (amorphous) state.

Materials that may be used in the construction of the expanded polymeric outer jacket include polymers such as (1) polymers that exhibit elastomeric properties at a predetermined temperature without chemical or radiation crosslinking, e.g. a desired recovery temperature which, if the polymer is crystalline, is below its crystalline melting range, i.e., thermoplastic polymers and co-polymers such as polytetrafluoroethylene, high molecular weight polypropylene, high molecular weight polyethylene, ultrahigh molecular weight polyethylene, etc., and (2) polymers and co-polymers, including polyolefins such as polyethylene and polypropylene, vinyls such as polyvinyl chloride and polyvinyl acetate and copolymers hereof, polyamides, etc., which have been cross-linked by chemical methods or by irradiation as by high energy electrons or other ionizing radiation. Further examples include polyolefins such as polyethylene and polypropylene, polyamides, polyurethanes, polyvinylchloride, polytetrafluoroethylene, polyvinylidenefluoride, polyethylenetetrafluoroethylene and polyesters. If the polymer is crystalline, the property of elastic memory can also be imparted without actual cross-linking to materials such as polytetrafluoroethylene and polyolefins or vinyl polymers that have a sufficiently high molecular weight to give the polymer appreciable strength at temperatures above the crystalline melting point.

Further examples of polymers suited for use in an expanded polymeric outer jacket include polyolefins, polyolefin copolymers, polyesters and polyvinyl halides, etc. Also useful are elastomers such as natural rubber, butadiene-styrene copolymers, butadiene-acrylonitrile copolymers, isoprene-isobutylene copolymers, polyisoprene, polybutadiene, polychloroprene, polysiloxanes, polymerized fluorocarbons, chlorosulfonated polyethylene, plasticized polyvinylchloride, polybutene, etc. Particularly useful polymers are the polyolefins, e.g., polyethylene; polypropylene; poly(butene-1); various copolymers of ethylene, propylene and butene; ethylene-ethylacrylate; ethylene-vinylacetate; and ethylene-methylacrylate copolymers, and blends of such copolymers containing major portions of polyethylene itself.

In an example embodiment of the invention, the expanded polymeric outer jacket is composed of one or more cross-linked polymers, one or more non-cross-linked polymers, or a combination thereof. For example, the expanded polymeric outer jacket may be composed of a cross-linked polyolefin polymer, a fluoropolymer, a cross-linked polyolefin copolymer, or a combination thereof. Likewise, the one or more cross-linked polymers may be selected from the group consisting of ethylene-methyl acrylate copolymer, low density polyethylene, ethylene-propylene-diene terpolymer, and combinations thereof. Some example materials that may be used in the manufacture of the expanded polymeric outer jacket include flame retardant EMA (ethylene-methyl acrylate copolymer) blend; flame-retardant LDPE/EPDM (low density polyethylene/ethylene-propylene-diene terpolymer) blend; and flame-retardant, zero halogen EMA blend.

The expanded polymeric outer jacket may also comprise dyes or colorants (including paint or other markings on the exterior of the outer wall, which may be added after expansion), flame-retardants, antioxidants, curing agents, accelerators, cross-linking agents, plasticizers, or similar additives, as long as the heat-recoverable functionality is not substantially impaired.

Unfilled polymers and in particular polyolefins and polyolefin copolymers are known to have very low thermal conductivities of about 0.06 to about 0.52 W/mK, and therefore they are unsatisfactory for use in the inner wall of a thermally conductive tubing system. As described herein, the thermal conductivity of these polymers is increased by addition of thermo-conductors within the inner wall. Example thermo-conductors may be selected from the group consisting of carbon (e.g., carbon black), a metal, a metal oxide, a metal nitride, a metal hydroxide, a metal carbonate, and combinations thereof. Additional examples of thermo-conductors include particulate silver, alumina (Al₂O₃), magnesium oxide, zinc oxide, silicon dioxide (SiO₂), boron nitride, aluminum nitride, and calcium carbonate (CaCO₃). Some example thermo-conductors include Thermax® N990 (carbon black, THERMAX® is a registered trademark of Cancarb Ltd. Corp., Alberta, Canada), Raven® UV Ultra® N110 (carbon black, RAVEN® and ULTRA® are registered trademarks of Columbian Chemicals Co., Marietta, Ga.), Alcoa T64-325Li tabular alumina from Alcoa, Inc. (Pittsburgh, Pa.), Alcan C75FG fine alumina powder from Alcan, Inc. (Quebec, Canada), and Omya Carb UFT (calcium carbonate) from Omya AG (Switzerland).

The inner wall is composed of a thermo-conductive adhesive composition, which comprises a thermo-conductor admixed with an adhesive. The relative amounts of thermo-conductor in the inner wall may range from, e.g., about 45 wt % to about 85 wt % based on the total weight of the adhesive composition. In an embodiment, the thermo-conductor is at least about 45% of the weight of the thermo-conductive adhesive composition of the inner wall. Similarly, the thermo-conductor may be at least about 50% and less than about 85% of the weight of the thermo-conductive adhesive composition of the inner wall. In yet another example embodiment, the thermo-conductor is at least about 70% and less than about 80% of the weight of the thermo-conductive adhesive composition of the inner wall. In another embodiment, the relative amounts of thermo-conductor in the inner wall ranges from, e.g., about 45 wt % to about 85 wt %; or in another embodiment, from about 50 wt % to about 85 wt %; or in yet another more particular embodiment, from about 70 wt % to about 80 wt %.

The relative amounts of adhesive in the inner wall range from, e.g., about 15 wt % to about 55 wt % based on the total weight of the inner wall. Ideally, the adhesive melts, softens, or flows upon being heated to (or above) a predetermined temperature, is non-foamable, bonds well during application and is not brittle when installed. The adhesive may be selected from the group consisting of solids, mastics, pressure sensitive adhesives, and combinations thereof. For example, the adhesive may be selected from the group consisting of polyethylene copolymers (e.g., ethylene copolymers), polyamides, and combinations thereof. In an embodiment, the adhesive has a melting point of from about 50° C. to about 230° C. (e.g., as determined by differential scanning calorimetry) or a ring-and-ball softening point of from about 60° C. to about 230° C.

In another embodiment, the adhesive is a solid at room temperature, and it melts or softens at a temperature sufficient to cause the expanded polymeric outer jacket to shrink. For example, the adhesive may be a hot-melt adhesive, which is a solid, thermoplastic material that melts quickly upon heating and then sets to a firm bond upon cooling. Hot-melt adhesives typically do not set by evaporation of a solvent, and some example ingredients of hot-melt adhesives include, among others, polyethylene, ethylene copolymers, polyamides, hydrocarbon and other tackifying resins, as well as asphalts, bitumens, resinous materials, and waxes.

The inner wall may also contain a crosslinking inhibitor material (e.g., antirad), which may be employed to prevent cross-linking during manufacture, as well as other materials, as long as the thermal conductivity thereof is not substantially impaired.

While the outer jacket preferably has low thermo-conductivity (e.g., less than about 0.5 W/mK), the inner wall adhesive layer is thermo-conductive. That is, the inner wall preferably has a greater thermal conductivity than the outer jacket. In an example embodiment, the thermo-conductive adhesive composition has a thermal conductivity of at least about 0.7 W/mK at about 40° C.±5° C. In another embodiment, the thermo-conductive adhesive composition has a thermal conductivity of at least about 1 (one) W/mK at about 40° C.±5° C. In yet another embodiment, the thermo-conductive adhesive composition has a thermal conductivity of at least about 5 (five) W/mK at about 40° C.±5° C.

The thermal conductivity is preferably determined, e.g., using a Unitherm™ Model 2021 Thermal Conductivity Measuring System (available from Anter Corp. of Pittsburgh, Pa.) at a temperature relatively far from a transition, e.g., a glass transition or melting point temperature. In calculating the thermal conductivity of a sample, the thickness used in the calculations may be determined at a temperature close to the equilibrium temperature when the heat flow is measured. Further details concerning methods for measuring the thermal conductivity are described in ASTM method E1530-93, entitled “Standard Test Method for Evaluating the Resistance to Thermal Transmission of Thin Specimens of Materials by the Guarded Heat Flow Meter Technique,” as approved on Jul. 15, 1993, and published in December 1993, which is incorporated herein by reference. Although other methods may be used to determine the thermal conductivity, such alternative methods should be in accordance with the principles set forth in the ASTM method. If the measurement is conducted at a temperature relatively far from a transition, the variation in thermal conductivity should be less than 10% over a 10° C. range, e.g. 40° C.±5° C., if no significant change in sample thickness occurs. Furthermore, any alternative methods or deviations from the ASTM method should have less than a 10% variation in the thermal conductivity over a 50° C. temperature range as compared to the thermal conductivity determined by the ASTM method.

Although in many instances it is preferable to co-extrude the inner wall to form a dual-wall product, it is also possible for the inner wall to be applied to the inside of the tubing, before or after it is expanded. The dual-wall tubing may be fabricated or formed in a predetermined configuration and then cross-linked. Although it is preferable to co-extrude the inner wall and the outer jacket, alternative methods are known in the art. For example, the outer jacket may be extruded and thereafter the inner wall may be coated along the interior. Accordingly, the polymeric outer jacket (i.e., the heat-shrinkable outer wall) of the tubing system may be extruded (or, if more than one layer, co-extruded) or molded in the desired shape. In this specification, the term “dual-wall” is intended to include products having two or more layers.

Where a simple tubular shape is desired it may be fabricated from a flat sheet of material simply by rolling it into a tube and suitably sealing the seam. Tubing may be supplied as a sheet that is rolled into position before application of heat. Recoverable articles are frequently used to cover objects having a tubular or otherwise regular elongate configuration, to provide, for example, environmental sealing protection. Where no free end of the elongate object is available, it is common practice to use a so-called wrap-around material, that is a material, typically in the form of a sheet, that is installed by wrapping it around the object to be covered so that opposed longitudinal edges overlap. In order to hold the wrap-around material around the object, a closure means may be applied to secure together the opposed longitudinal edges; although one skilled in the art will readily appreciate that, depending on the particular application, the adhesive component may be sufficient to seal the material to the object. Additionally, the tubing system may be in the form of an end cap, having a cylindrical form in which one end is closed. Accordingly, as used herein a tubing system is meant to include objects having a cylindrical shape, as well as planar materials that may be rolled up or wrapped around an object in a cylindrical manner, as well as other geometric configurations. In an example embodiment, the tubing system is a dual-wall, heat-shrinkable tube having a substantially cylindrical shape.

For example, the tubing system may be substantially cylindrical and have a ratio of the inner diameter of the expanded tubing to the inner diameter of the recovered tubing (recovery ratio) of from about 1.2 to about 6, or much larger. The inner wall and the expanded polymeric outer jacket taken together may have a thickness of from about 0.5 mm (0.020 in) to about 5 mm (0.200 in).

One skilled in the art will appreciate that a tubing system may comprise two separate components. For example, the inner wall of the tubing system may be provided by a tape that is wrapped around an article; and the expanded polymeric outer jacket may be provided as a separate component that is installed over the wrapped tape. In a similar manner, the inner wall and the expanded polymeric outer jacket may both be provided as separate sleeves that are installed around an article prior to the application of heat. The tubing system may also be provided as a one-component system in which the inner wall and the expanded polymeric jacket are present together in one article of manufacture.

In another embodiment, the invention provides a method of making an expanded dual-wall, heat-shrinkable tubing system comprising the steps of (1) co-extruding a dual-wall tubing having an inner wall and an outer jacket surrounding and in contact with the inner wall, wherein an inner wall is composed of a thermo-conductive adhesive composition comprising a thermo-conductor admixed with an adhesive, wherein the thermo-conductor is at least about 45% of the weight of the thermo-conductive adhesive composition; and the outer jacket comprises a cross-linkable polymer; (2) cross-linking the cross-linkable polymer; (3) expanding the dual-wall tubing, e.g., by applying heat and pressure or by other means; and (4) cooling the dual-wall tubing to thereby produce an expanded dual-wall, heat-shrinkable tubing system.

The cross-linking may be accomplished by a chemical cross-linking technique wherein a cross-linking agent is added, the subsequent application of heat or ultraviolet light bringing about the desired cure. Alternatively, the cross-linking may be brought about by exposure of the material to high energy radiation such as from accelerated electrons, X-rays, gamma rays, alpha particles, beta particles, neutrons, and the like, without the necessity for the addition of a cross-linking agent. Generally, the minimum radiation dosage is of the order of 2×10⁶ rads.

In order to expand a cross-linked polymer, it may be heated to a temperature sufficiently high to soften it and maintained at that temperature while an internal force or forces are applied to change the size or shape. For example, tubing may be forced through a heated die in order to expand the outer jacket. Afterwards, the expanded material may be cooled or quenched while still under the internal deforming stresses, whereupon the material will retain the expanded shape upon the release of the stresses. The material is now in the heat-recoverable (i.e., heat-shrinkable) state but may be left for an indefinite period of time at room temperature without it recovering back to its original size and shape. The expanded tubing has a diameter greater than the original diameter of the extruded material.

The use of a heat-shrinkable tubing system of the invention is simple and straight-forward. The tubing is simply put into position for use and heat is applied to it, whereupon the material will recover to its original configuration. For example, expanded tubing is placed over an article that is desired to be encapsulated, adequate clearance between the tubing and the article being provided to permit easy application. Brief application of heat to the expanded tubing will cause it to shrink and attempt to return to its original dimensions. This recovery permits the tubing to tightly clad and cover the article that has been inserted therein prior to the application of heat. Such a process finds use in the covering of a group of cables, pipes, wires and the like, the resulting jacket providing the desired toughness, abrasion resistance and other properties, as well as thermo-conductivity.

In an example embodiment, the invention includes a method of sealing one or more articles comprising the steps of (1) providing one or more articles to be sealed, a thermo-conductive adhesive composition, and an expanded polymeric outer jacket; (2) placing the thermo-conductive adhesive composition around the articles and within the expanded polymeric outer jacket; and thereafter (3) heating the expanded polymeric outer jacket to or above a predetermined temperature, thereby producing a recovered polymeric outer jacket and bringing the thermo-conductive adhesive composition into contact with the articles while leaving essentially no voids between the thermo-conductive adhesive composition and the article and within the adhesive composition, and, preferably, leaving no voids within the recovered polymeric outer jacket. The thermo-conductive adhesive composition comprises a thermo-conductor admixed with an adhesive, and the thermo-conductor is at least about 45% of the weight of the thermo-conductive adhesive composition. The expanded polymeric outer jacket recovers at or above the predetermined temperature. The adhesive (or the inner wall) melts or softens at or above the predetermined temperature.

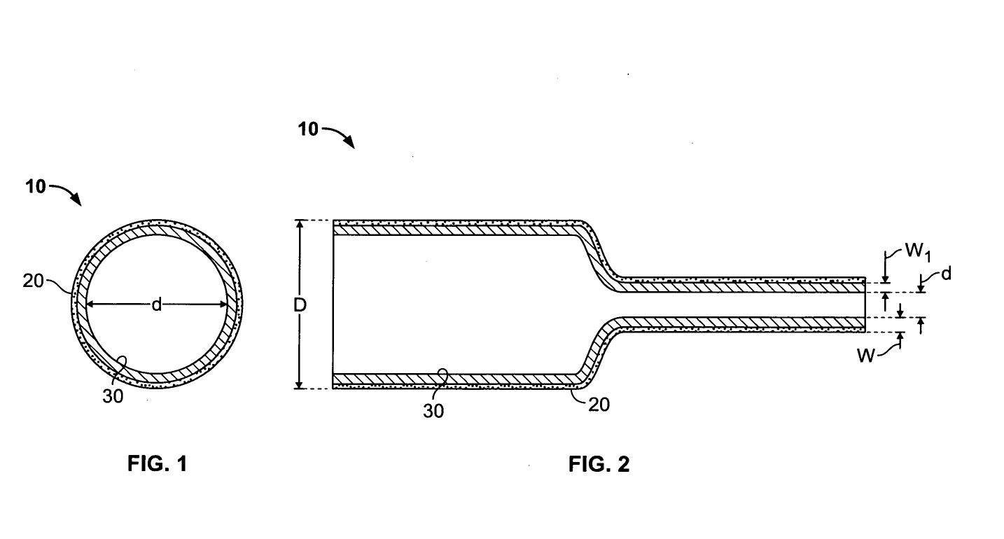

Referring to the Drawings, FIG. 1 and FIG. 2 provide two different cross-sectional views of an example tubing 10 of the invention. FIG. 1, which is not to scale, illustrates an axial cross-sectional view of an example tubing 10 of the invention. FIG. 2, which is also not to scale, illustrates a longitudinal cross-sectional view of an example tubing 10 of the invention. The dual-wall tubing 10 includes an outer jacket 20 and an inner wall 30.

FIG. 2 illustrates the decrease in the inner diameter, d, and the outer diameter, D, upon application of heat to the tubing 10. The inner wall as depicted in FIG. 2 has a thickness W₁ and a total wall thickness (inner wall 30 and outer jacket 20) of W.

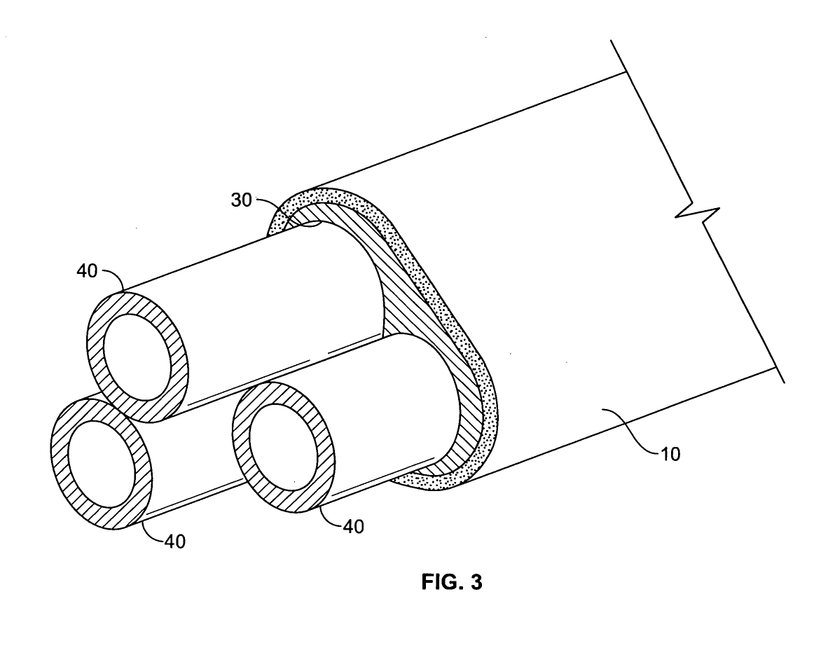

FIG. 3 is not to scale and illustrates an assembly of three pipes 40 bundled together within an example thermo-conductive, heat-shrinkable, dual-wall tubing 10 of the invention. As illustrated, the outer jacket 20 of the tubing 10 has been heat-shrunk to conform to the three pipes 40 within. The inner wall 30 is in intimate contact with the pipes 40 around which the tubing 10 is situated, and the adhesive and thermo-conductive components of the inner wall 30 have become distributed in the interstitial spaces between the pipes 40 thereby placing them in thermal communication with each other.

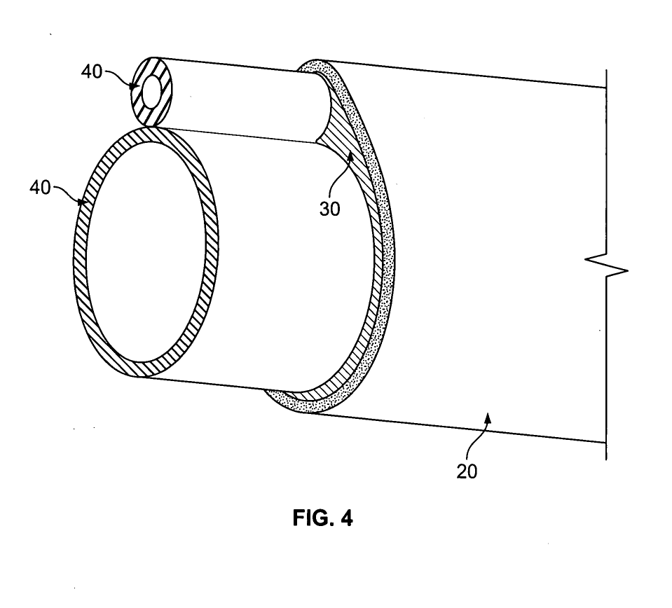

FIG. 4 is not to scale and illustrates a perspective view of two pipes 40 of different sizes within a recovered tubing 10, which has been partially removed to expose the pipes 40 within. The thermo-conductive adhesive composition 30 is in contact with the outer jacket 20 and the two pipes 40. Upon shrinking, the outer jacket 20 has compressed the thermo-conductive adhesive composition into contact with the pipes 40, leaving essentially no voids or air pockets. Application of heat during the shrinking process causes the outer jacket 20 to shrink in addition to melting or softening the thermo-conductive adhesive composition 30. In this manner, the two pipes 20 are placed in thermal communication.

The invention is further illustrated by the following examples, which should not be construed as further limiting.

### EXAMPLES

Laboratory blends of thermo-conductive adhesives were made on a 76 mm (3 in) diameter, two-roll mill that was heated to 135° C. These compositions were made by mixing of a blend of poly(ethylene, vinyl acetate, methacrylic acid) terpolymer, aromatic tackifier and stabilizers with a DSC melting point of 69° C. and ring-and-ball softening point of 82.5° C. (referred to herein as “Adhesive A”) with carbon black and alumina thermo-conductive powders at 45-70% level. The following powders were used: Thermax® N990 carbon black, Raven® UV Ultra® carbon black, tabular Alcoa T64-325Li alumina, fine Alcan C-75-FG alumina and Omya Carb UFT calcium carbonate. Slabs, 15 cm×15 cm×2 mm (6 in×6 in×0.080 in), were pressed from these blends in an electric press at 180° C. and were measured for thermal conductivity. Measurements were conducted at 35.7-41.9° C. using a guarded heat flow method in accordance with the principles described in ASTM E1530-93. The compositions and results are listed in the Table herein below. Materials having thermal conductivity values of about 1.0-5.0 W/mK, having suitable flow and with good flexibility were selected for further analysis. Based on the results of this study all Samples showed an improvement in thermal conductivity over Sample 0 (the control sample).

Thermo-Conductive Adhesive Compositions

| | Composition | Conductivity | Temperature^{B} | |
|---|---|---|---|---|
| Sample | (wt %) | (W/mK) | (° C.) | Comments |
| 0 | Adhesive A | 0.20 | 35.7 | Flexible |
| | (control) | | | |
| 1 | Adhesive A | 0.44 | 37.6 | Flexible |
| | 40% Thermax N990 | | | |
| | 5% Raven UV | | | |
| 2 | Adhesive A | 0.78 | 38.4 | Brittle |
| | 63.2% Thermax N990 | | | |
| | 7.8% Raven UV | | | |
| 3 | Adhesive A | 0.35^{A} | 36.0, 37.2 | Flexible |
| | 31.5% Tabular alumina T64-325Li | | | |
| | 13.5% Alcan C75FG alumina | | | |
| 4 | Adhesive A | 1.18^{A} | 39.0, 40.0 | Flexible |
| | 49.0% Tabular alumina T64-325Li | | | |
| | 21.0% Alcan C75FG alumina | | | |
| 5 | 50% Adhesive A | 0.41 | 37.0 | Flexible |
| | 50% Omya Carb UFT (CaCO₃) | | | |
| 6 | 40% Adhesive A | 0.48 | 37.4 | Flexible |
| | 60% Omya Carb UFT (CaCO₃) | | | |
| 7 | 30% Adhesive A | 0.65 | 37.9 | Flexible |
| | 70% Omya Carb UFT (CaCO₃) | | | |
| 8 | 20% Adhesive A | 1.01 | 38.4 | Brittle |
| | 80% Omya Carb UFT (CaCO₃) | | | |
| 9 | 30% Adhesive A | 1.11 | 40.5 | Flexible |
| | 70% Calcined Alumina A14-325 | | | |
| 10 | 20% Adhesive A | 1.77 | 41.5 | Semi-flexible |
| | 80% Calcined Alumina A14-325 | | | |
| 11 | 30% Adhesive A | 1.38 | 40.5 | Flexible |
| | 70% Calcined Alumina A14-UNG | | | |
| 12 | 20% Adhesive A | 2.29 | 41.2 | Brittle |
| | 80% Calcined Alumina A14-UNG | | | |
| 13 | 30% Adhesive A | 1.35 | 40.2 | Flexible |
| | 21% Calcined Alumina A14-325 | | | |
| | 49% Calcined Alumina A14-UNG | | | |
| 14 | 20% Adhesive A | 2.30 | 41.9 | Brittle |
| | 24% Calcined Alumina A14-325 | | | |
| | 56% Calcined Alumina A14-UNG | | | |
| 15 | 25% Adhesive A | 1.41 | 40.8 | Flexible |
| | 75% Calcined Alumina A14-325 | | | |
| 16 | 25% Adhesive A | 1.84 | 41.0 | Semi-flexible |
| | 75% Calcined Alumina A14-UNG | | | |
| 17 | 30% Adhesive A | 1.16 | 40.5 | Brittle |
| | 70% Polar Therm PT110 Boron nitride | | | |
| 18 | 35% Adhesive A | 0.97 | 41.5 | Brittle |
| | 65% Polar Therm PT120 Boron nitride | | | |
| 19 | 33% Adhesive A | 1.15 | 40.5 | Brittle |
| | 67% Polar Therm PT620 Boron nitride | | | |
| 20 | 30% Adhesive A | 2.52 | 41.2 | Brittle |
| | 70% Polar Therm PT670 Boron nitride | | | |
| 21 | 20% Adhesive A | 5.21 | 41.2 | Brittle |
| | 80% Polar Therm PT670 Boron nitride | | | |
| 22 | 30% Adhesive A | 2.58 | 41.9 | Brittle |
| | 45% Polar Therm PT670 | | | |
| | 25% Calcined Alumina A14-325 | | | |
| 23 | 30% Adhesive A | 2.18 | 40.8 | Brittle |
| | 45% Polar Therm PT670 | | | |
| | 25% Calcined Alumina A14-UNG | | | |
| 24 | 30% Adhesive A | 2.22 | 41.0 | Semi-flexible |
| | 35% Polar Therm PT670 | | | |
| | 35% Calcined Alumina A14-325 | | | |
| 25 | 30% Adhesive A | 2.10 | 40.2 | Semi-flexible |
| | 35% Polar Therm PT670 | | | |
| | 35% Calcined Alumina A14-UNG | | | |
| 26 | 30% Adhesive A | 1.99 | 41.9 | Semi-flexible |
| | 25% Polar Therm PT670 | | | |
| | 45% Calcined Alumina A14-325 | | | |
| 27 | 30% Adhesive A | 1.54 | 40.8 | Semi-flexible |
| | 25% Polar Therm PT670 | | | |
| | 45% Calcined Alumina A14-UNG | | | |

^{A}= Average of two measurements.
^{B}= Temperature at which conductivity was measured.
Thermax N990 = carbon black from Cancarb Chemicals
Raven UV = carbon black from Columbian Chemicals
EMA = ethylene-methyl acrylate copolymer
EPDM = ethylene-propylene-diene terpolymer
Calcined Alumina A14-325 Mesh from Almatis
Calcined Alumina A14-UNG (unground) from Almatis
Polar Therm PT110 Boron nitride from GE Advanced Ceramics
Polar Therm PT120 Boron nitride from GE Advanced Ceramics
Polar Therm PT620 Boron nitride from GE Advanced Ceramics
Polar Therm PT670 Boron nitride from GE Advanced Ceramics

Sample 4 was chosen for a scale up. The two alumina powders were tumble blended at a ratio of 70% by weight of tabular Alcoa T64-325Li alumina and 30% by weight of fine Alcan C-75-FG alumina. This powder blend and Adhesive A were blended at a ratio of 70% to 30% by weight in a mixer under heat and shear. This blend was pelletized in a Gala pelletizer (Gala Industries, Inc., Eagle Rock, Va.) with water temperature of 15° C. The dual-wall tubing was co-extruded with a flame-retardant EMA blend jacket on a 51 mm (2 in) Davis Standard extruder (Davis-Standard, LLC, Pawcatuck, Conn.). The extrusion temperature profile for the jacket was from 116° C. to 201° C. The adhesive was co-extruded on a 32 mm (1.25 in) Davis Standard extruder, with an extrusion temperature profile for adhesive from 79° C. to 104° C. with water cooling. The dual-wall tubing had extruded OD (outside diameter) of 7.1 mm (0.281 in), extruded ID (inside diameter) of 3.7 mm (0.145 in) and total average wall thickness of 1.4 mm (0.054 inch). It was irradiated to 14 Mrads in 1.5 MeV electron beam and was expanded in a pressure expander at 116° C. (240° F.) to produce tubing of expanded ID of 13.2 mm (0.520 in) with recovered ID of 3.96 mm (0.156 in) and wall thickness of 1.4-1.5 mm (0.055-0.058 in).

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to any particular embodiment disclosed as the best mode contemplated for carrying out this invention, but that the invention will include all embodiments falling within the scope of the appended claims.

1. A tubing system comprising
an inner wall composed of a thermo-conductive adhesive composition, wherein said thermo-conductive adhesive composition comprises a thermo-conductor admixed with an adhesive, and said thermo-conductor is at least about 45% of the weight of said thermo-conductive adhesive composition; and
an expanded polymeric outer jacket surrounding and in contact with said inner wall, wherein said expanded polymeric outer jacket recovers at or above a predetermined temperature.

2. The tubing system according to claim 1, wherein said thermo-conductive adhesive composition has a thermal conductivity of at least about 0.7 W/mK at about 40° C.±5° C.

3. The tubing system according to claim 1, wherein said thermo-conductive adhesive composition has a thermal conductivity of at least about 1 W/mK at about 40° C.±5° C.

4. The tubing system according to claim 1, wherein said thermo-conductive adhesive composition has a thermal conductivity of at least about 5 W/mK at about 40° C.±5° C.

5. The tubing system according to claim 1, wherein said inner wall is non-foamable.

6. The tubing system according to claim 1, wherein said thermo-conductor is at least about 50% and less than about 85% of the weight of said thermo-conductive adhesive composition.

7. The tubing system according to claim 1, wherein said thermo-conductor is at least about 70% and less than about 80% of the weight of said thermo-conductive adhesive composition.

8. The tubing system according to claim 1, wherein said thermo-conductor is selected from the group consisting of carbon, a metal, a metal oxide, a metal nitride, a metal hydroxide, a metal carbonate, and combinations thereof.

9. The tubing system according to claim 8, wherein said metal is particulate silver.

10. The tubing system according to claim 8, wherein said metal oxide is a powder selected from the group consisting of alumina, magnesium oxide, zinc oxide, and silicon dioxide.

11. The tubing system according to claim 8, wherein said metal nitride is a powder selected from the group consisting of aluminum nitride and boron nitride.

12. The tubing system according to claim 8, wherein said metal carbonate is calcium carbonate.

13. The tubing system according to claim 1, wherein said adhesive melts or softens at or above said predetermined temperature.

14. The tubing system according to claim 1, wherein said adhesive has a melting point of from about 50° C. to about 200° C. or a ring-and-ball softening point of from about 60° C. to about 200° C.

15. The tubing system according to claim 1, wherein said adhesive is selected from the group consisting of polyethylene copolymers, polyamides, and combinations thereof.

16. The tubing system according to claim 1, wherein said expanded polymeric outer jacket is composed of one or more cross-linked polymers, one or more non-cross-linked polymers, or a combination thereof.

17. The tubing system according to claim 16, wherein said expanded polymeric outer jacket is composed of a cross-linked polyolefin polymer, a fluoropolymer, a cross-linked polyolefin copolymer, or a combination thereof.

18. The tubing system according to claim 16, wherein said one or more cross-linked polymers are selected from the group consisting of ethylene-methyl acrylate copolymer, low density polyethylene, ethylene-propylene-diene terpolymer, and combinations thereof.

19. The tubing system according to claim 1, wherein
said expanded polymeric outer jacket is substantially cylindrical,
said expanded polymeric outer jacket has a recovery ratio of from about 1.2 to about 6, and
said inner wall and said expanded polymeric outer jacket taken together have a thickness of from about 0.5 mm (0.020 in) to about 5 mm (0.200 in).

20. A method of sealing one or more articles comprising
providing one or more articles to be sealed, a thermo-conductive adhesive composition, and an expanded polymeric outer jacket;
placing said thermo-conductive adhesive composition around said articles and within said expanded polymeric outer jacket; and thereafter heating said expanded polymeric outer jacket to or above a predetermined temperature, thereby producing a recovered polymeric outer jacket and sealing said thermo-conductive adhesive composition into contact with said articles while leaving essentially no voids within said thermo-conductive adhesive; wherein
said thermo-conductive adhesive composition comprises a thermo-conductor admixed with an adhesive,
said thermo-conductor is at least about 45% of the weight of said thermo-conductive adhesive composition,
said expanded polymeric outer jacket recovers at or above said predetermined temperature, and
said adhesive melts or softens at or above said predetermined temperature.
